(19) United States
(12) Patent Application Publication
(10) Pub. No.: US 2025/0150800 A1
(43) Pub. Date: May 8, 2025

(54) RELIABILITY CHECK SYSTEM FOR UNEXPECTED SITUATION DETECTION INFORMATION IN MIXED TRAFFIC FLOW OF MIX OF AUTONOMOUS AND NON-AUTONOMOUS VEHICLES AND METHOD THEREOF

(71) Applicant: KIAPI(Korea Intelligent Automotive Parts Promotion Institute), Daegu (KR)

(72) Inventors: SE YEONG KIM, Daegu (KR); JONG HO HAN, Daegu (KR); YUN KI YOON, Incheon (KR); BONG SEOB KIM, Daegu (KR); KYUNG SU YUN, Daegu (KR)

(21) Appl. No.: 18/929,766

(22) Filed: Oct. 29, 2024

(30) Foreign Application Priority Data
Nov. 6, 2023 (KR) 10-2023-0152169

(51) Int. Cl. H04W 4/90; G07C 5/08

(52) U.S. Cl. CPC H04W 4/90; G07C 5/0816

(57) ABSTRACT

A reliability check system for unexpected situation detection information in a mixed traffic flow of a mix of autonomous and non-autonomous vehicles includes a sensor unit configured to detect emergency and disaster situations on or around a road, including at least one of a camera, a lidar, and a radar, an emergency determination unit configured to analyze information received from the sensor unit to determine an emergency type, a controller configured to classify a set grade according to detection information from the emergency determination unit and transmit a response manual to an autonomous vehicle and an on-site terminal, and a data checking unit configured to verify at least one of whether firmware of the information received from the emergency determination unit has been falsified, whether a vehicle is hacked by remote control, whether CAN tampering occurred, and whether communication channel tampering occurred, and transmit verified data to the controller.

### CROSS-REFERENCE TO RELATED APPLICATION AND CLAIM OF PRIORITY

This application claims the benefit under 35 USC § 119 of Korean Patent Application No. 10-2023-0152169 filed on Nov. 6, 2023, in the Korean Intellectual Property Office, the entire disclosure of which is incorporated herein by reference for all purposes.

### BACKGROUND

### 1. Field

The present disclosure relates to a system and method for checking the reliability of unexpected situation detection information in a mixed traffic flow of a mix of autonomous and non-autonomous vehicles.

### 2. Description of the Related Art

In the related art, a traffic control system using a communication network to control real-time traffic conditions on major roads including highways has been disclosed.

The traffic control system collects traffic information by analyzing traffic conditions on the road through digital signal processing of images obtained from traffic surveillance cameras installed on the road to capture images of vehicles that pass by and provides the collected traffic information externally in real time through broadcasting.

Therefore, when a disaster (accident, earthquake, fire, heavy snow, or rain) occurs on the road, the remote control system issues a disaster warning to relevant organizations based on the information collected through the cameras and provides information on the scene.

However, recently, as a mixed traffic flow situation includes autonomous vehicles that drive autonomously, analysis and control of traffic situations on the road also has to be performed based thereon.

However, it may be difficult to control emergencies and disasters in the current mixed traffic situation in which autonomous vehicles are mixed with general vehicles in the existing traffic control system, and it has not been easy to respond to emergencies (autonomous vehicle breakdowns or accidents) caused by autonomous vehicles.

In addition, due to the recent development of communication technology, cases in which on-site surveillance equipment and operating algorithms are hacked have occurred frequently, and thus, if distorted information different from the site is transmitted, it may be difficult to recognize the distorted information, thereby making it difficult to establish rapid countermeasures appropriate for the on-site situation. In other words, there was no way to confirm the reliability of information received from the site in the related art.

### SUMMARY

An aspect of the present disclosure is to provide a reliability check system and method for improving the reliability of detection information when providing information to an autonomous vehicle after an on-site infrastructure detects an unexpected situation occurring in a mixed traffic flow situation in which an autonomous vehicle and a general vehicle are mixed.

In an aspect, a reliability check system for unexpected situation detection information in a mixed traffic flow of a mix of autonomous and non-autonomous vehicles includes: a sensor unit configured to detect emergency and disaster situations on or around a road, including at least one of a camera, a lidar, and a radar; an emergency determination unit configured to analyze information received from the sensor unit to determine an emergency type; a controller configured to classify a set grade according to detection information from the emergency determination unit and transmit a response manual to an autonomous vehicle and an on-site terminal; and a data checking unit configured to verify at least one of whether firmware of the information received from the emergency determination unit has been falsified, whether a vehicle is hacked by remote control, whether CAN tampering occurred, and whether communication channel tampering occurred, and transmit verified data to the controller.

The emergency determination unit may include: a sensor information collecting module configured to collect at least one of 2D type object location information as coordinate system information and 3D type object location information, an object speed, an object direction, a blocked lane, and an emergency type as latitude and longitude information; and a sensor data determination module configured to determine the data of the sensor unit to detect a type of an emergency situation, a section in which the emergency situation occurred, location information, and whether the sensor is broken.

The emergency determination unit may detect a failure in at least one of the camera, lidar, and radar and determine whether to transmit data to the data checking unit.

The data checking unit may detect whether there is an abnormality in a transmission location among the information received from the emergency determination unit and re-request the corresponding information from the emergency determination unit or block the corresponding information based on a detection result.

The data checking unit may send verified information to the controller and transmit at least one of the information transmitted to the controller, signal information, and detour path information for avoiding an unexpected point to a surrounding autonomous vehicle and an infrastructure.

In another aspect, a reliability check method for unexpected situation detection information in a mixed traffic flow of a mix of autonomous and non-autonomous vehicles includes: a) receiving, by an emergency determination unit, sensor data from a sensor unit including at least one of a camera, a lidar, and a radar and transmitting information including an emergency type and location; b) verifying, by a data checking unit, at least one of whether firmware of the information received from the emergency determination has been falsified, whether a vehicle is hacked by remote control, whether CAN tampering occurred, whether communication channel tampering occurred, and whether integrity has been achieved; and c) transmitting, by the data checking unit, information received from the emergency determination unit to a controller or blocking the information according to a verification result.

In the reliability check method, a) may include checking, by the emergency determination unit, the sensor data of the sensor unit and detecting and alerting for a failure.

In the reliability check method, b) may further include, determining, by the data checking unit, whether there is an abnormality in a transmission location among the information of the emergency determination unit and requesting retransmission from the emergency determination unit or blocking the corresponding information if an abnormality is detected.

Therefore, in the present disclosure, information is collected from infrastructure, on-site terminals, and autonomous vehicles, etc., a source and falsification of the information is determined, and traveling of an autonomous vehicle is supported based on information confirmed by a control center, thereby enabling a safe autonomous driving service.

### BRIEF DESCRIPTION OF THE DRAWINGS

FIG. 1 is a block diagram illustrating an overview of a road control system and control method capable of securing the reliability of on-site information in the event of an emergency or disaster according to the present disclosure.

FIG. 2 is a block diagram illustrating a sensor unit.

FIGS. 3 and 4 are block diagram illustrating an emergency determination unit.

FIG. 5 is a block diagram illustrating a data checking unit.

FIG. 6 is a flowchart illustrating a control method of a road control system capable of securing the reliability of on-site information in the event of an emergency or disaster according to the present disclosure.

### DETAILED DESCRIPTION OF THE EMBODIMENTS

Prior to the description, it should be understood that the terms used in the specification and the appended claims should not be construed as limited to general and dictionary meanings, but interpreted based on the meanings and concepts corresponding to technical aspects of the present disclosure based on the principle that the inventor is allowed to define terms.

Throughout the specification, when a part is referred to as “including” a certain element, it means that it may further include other elements rather than exclude other elements, unless specifically indicated otherwise. In the description, the terms such as “ . . . unit”, “ . . . er/or”, “ . . . module”, and the like refer to units that process at least one function or operation, which may be implemented with a hardware, a software or a combination thereof.

Disaster situations described throughout the specification generally refer to accidents caused by natural environments such as earthquakes, floods, heavy snow, landslides, explosions, fires, etc., as well as accidents caused by man-made factors. Emergency may include vehicle breakdowns, explosions, and fires occurring on the road, collisions or contacts between vehicles (including all devices that may be driven on the road such as automobiles, two-wheeled vehicles, bicycles, and kickboards), between vehicles and pedestrians, and between vehicles and animals, and abnormal conditions and environments that emergently occur on or around the road such as falling rocks and icy roads.

Hereinafter, embodiments of the present disclosure will be described in detail with reference to the accompanying drawings.

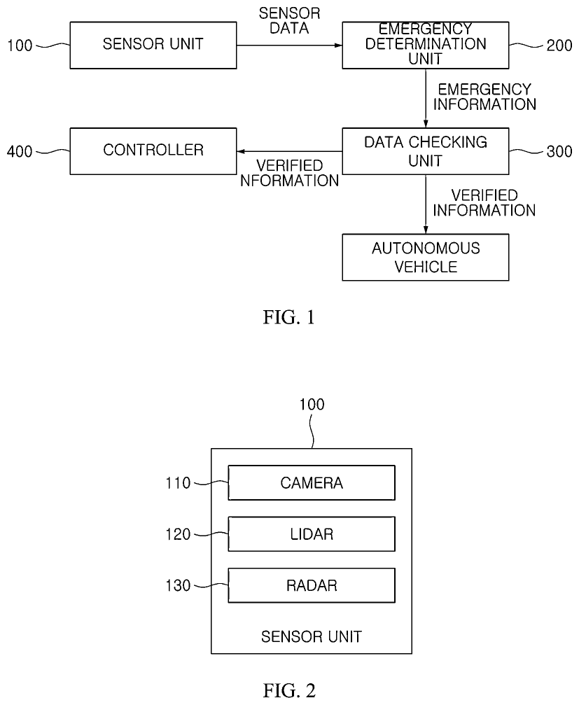

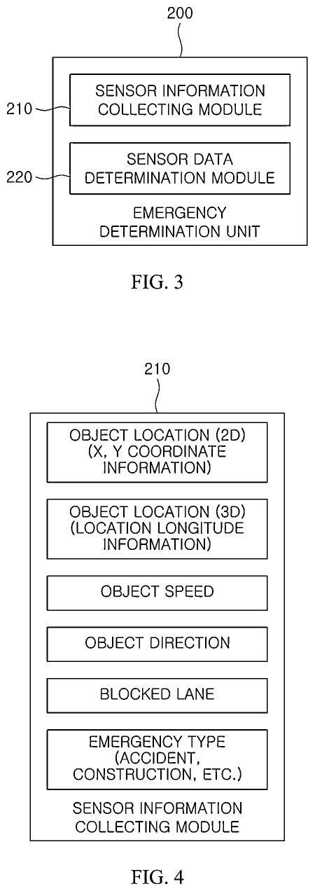

FIG. 1 is a block diagram illustrating an outline of a road control system and control method capable of securing the reliability of on-site information in the event of an emergency or disaster situation according to the present disclosure, FIG. 2 is a block diagram illustrating a sensor unit 100, and FIG. 3 and FIG. 4 are block diagrams illustrating an emergency determination unit 200.

Referring to FIGS. 1 to 4, the present disclosure may include a sensor unit 100 that monitors a scene, an emergency determination unit 200 that determines an emergency type and section according to an emergency detection signal of the sensor unit 100, a data checking unit 300 that verifies the reliability of information received from the emergency determination unit 200, a controller 400 that receives verified information from the data checking unit 300, and an autonomous vehicle (no reference numeral).

The sensor unit 100 may include a camera 110, a lidar 120, and a radar 130 installed around the road to detect an emergency situation.

Referring to FIGS. 3 and 4, the emergency determination unit 200 may include a sensor information collecting module 210 that collects sensor data of the sensor unit 100 and a sensor data determination module 220 that determines whether a sensor is broken, an emergency type, and an emergency section through the sensor data.

The sensor information collecting module 210 collects at least one of 2D type object location information (e.g., x, y coordinate information, 3D type object location information (e.g., latitude, longitude information), an object speed, an object direction, a blocked lane, and an emergency type (e.g., accident occurrence, construction location or type) as shown in FIG. 4.

The sensor data determination module 220 fuses the data of each sensor to determine the emergency type of a road situation in which autonomous vehicles are mixed and a section in which an unexpected situation occurred.

Here, the emergency type may include an existing emergency type (traffic accidents, jaywalking, flooding, heavy snow, overflow, rockfall, fog, road damage, fire, earthquake, etc.) and an emergency type related to an autonomous vehicle (a breakdown of an autonomous vehicle, an accident of an autonomous vehicle, etc.).

In addition, the sensor data determination module 220 may determine the emergency type and whether data is transmitted based on a failure of each sensor before fusion of the sensor data received from the sensor unit 100.

For example, the sensor data determination module 220 may determine a failure if the sensor data (e.g., vehicle location, object detection data, etc.) detected and transmitted by the sensor unit 100 includes data that is different from an existing format or data that cannot be ascertained.

Also, in the case of a failure of the camera 110 or the lidar 120, the emergency determination unit including the sensor data determination module 220 may determine the emergency type and transmit information to the controller 400 and/or the data checking unit 300.

Alternatively, in the case of a failure of the radar 130, the sensor data determination module 220 may not determine the emergency type and transmit a determination failure message to the controller 400. The determination failure message is output to the controller 400. Therefore, the controller 400 may quickly transmit a status of the emergency determination unit 200.

Alternatively, in the case of a failure of the camera 110 and lidar 120, the sensor data determination module 220 may determine the emergency type and transmit information to the controller 400 and/or the data checking unit 300.

Alternatively, the sensor data determination module 220 may be a combination of an emergency situation determination system and an on-site control system.

That is, the sensor data determination module 220 may be integrated with the sensor unit 100 (e.g., the camera 110, the lidar 120, and the radar 130) to detect an emergency situation on the road and determine the type of the emergency situation.

In addition, the sensor data determination module 220 may also transmit strategy data for on-site control according to the emergency type to a nearby autonomous vehicle.

The data checking unit 300 checks sensor data fused in the emergency determination unit 200, verifies the reliability, and then transmits a result to the controller 400. In addition, the data checking unit may send the verified information to the controller and, at the same time, transmit the information sent to the controller, signal information (SPat data), and detour path information for avoiding an emergency point to the nearby autonomous vehicle.

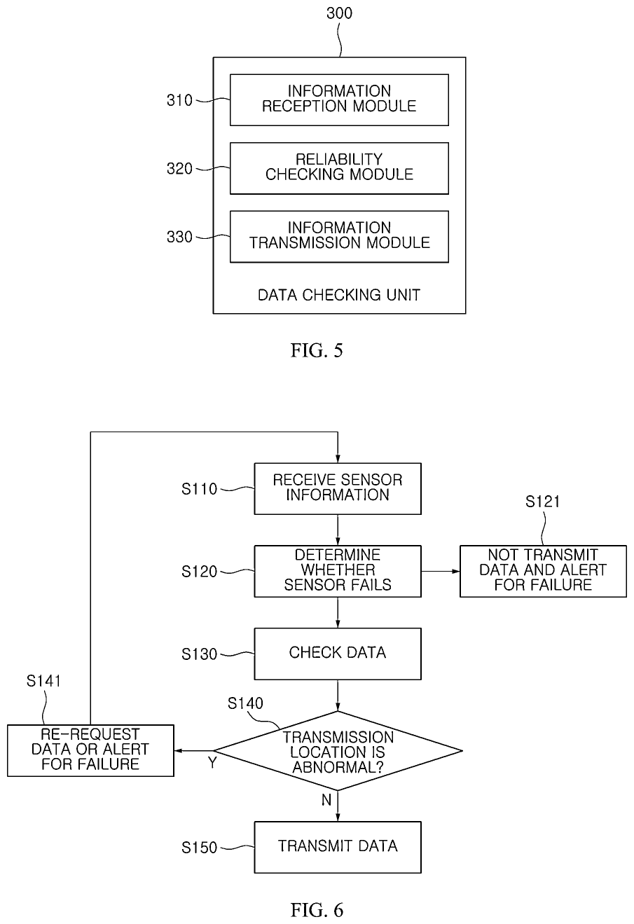

FIG. 5 is a block diagram illustrating the data checking unit.

Referring to FIG. 4, the data checking unit 300 may include an information reception module 310 that receives information from the emergency determination unit 200, a reliability checking module 320 that verifies the reliability of the information received from the information reception module 310, and an information transmission module 330 that transmits a reliability check result to the controller 400.

The information reception module 310 receives emergency information including an emergency type and an emergency section (location) from the emergency determination unit 200.

The reliability checking module 320 may evaluate the reliability by diagnosing the integrity of the received emergency information and checking falsification of data and a transmission location and may check for abnormalities according to a set evaluation criteria. Here, the reliability checking module 320 may check the location information and re-request the location information if there is an abnormality. If an abnormality is detected again in the location information received upon the re-request, the reliability checking module 320 may transmit abnormality information to the controller 400.

In addition, if an abnormality is detected through data falsification and integrity diagnosis, the reliability checking module 320 may block data transmission to the controller 400.

For example, the reliability checking module 320 may check at least one of whether firmware has been falsified, whether a vehicle is hacked by remote control, whether CAN tampering occurred, and whether communication channel tampering occurred.

Among them, a firmware falsification response may include at least one of hardware security module (HSM), which is a device that generates and stores an encryption key in hardware, Secure Boot, which checks integrity information in the order of CPU->Bootloader->Kernel->RootFS, and Secure Diagnosis.

A vehicle remote control hacking response may be performed through at least one of Secure Diagnosis, intrusion detection system (IDS), intrusion prevention system (IPS), and SecOC.

A CAN tampering response may be performed through IDS or SecOC, and a communication channel tampering response may be performed through any one of Ipsec or Wave communication security technology.

The examples mentioned above are not limited, and in addition, any technology that may detect firmware falsification, vehicle remote control hacking, CAN tampering, and communication channel tampering may be applied.

The controller 400 is, for example, a control system built through a server or a plurality of terminals, a server and a network. When reliable sensor data detection information is received, a reliability grade may be classified based thereon and transmitted to an autonomous vehicle and infrastructure.

Here, the infrastructure, as devices, such as the sensor unit 100, the emergency detection unit 200, the data checking unit 300, and other communication-available devices, refers to facilities around the road that are connected to each other through a communication network.

An example of reliability grade classification based on sensor data detection information is as follows.

An example of reliability grades
Grade A: All three sensors are normal/Emergency information is transmitted to autonomous vehicle and control center
Grade B: One or two sensors fail/Emergency information is transmitted and it is notified that reliability is not high
Grade C: Three sensors fail/Emergency information is not transmitted

In addition, the controller 400 retransmits the checked information (an emergency location, emergency type, etc.) to the infrastructure built by the sensor unit 100, the emergency determination unit 200, the data checking unit 300, and other communication-available facilities. Here, if the received information does not match, the controller 400 may correct the information and then transmit the same.

In addition, when confirmed information is received from the controller 400, the data checking unit 300 may determine whether to selectively transmit the corresponding information to the nearby autonomous vehicle and infrastructure and transmit the same.

The present disclosure includes the aforementioned configuration, and hereinafter, a control method of a road control system capable of securing reliability of on-site information in the event of an emergency or disaster according to the present disclosure is described.

FIG. 6 is a flowchart illustrating a control method of a road control system capable of securing reliability of on-site information in the event of an emergency or disaster according to the present disclosure.

Referring to FIG. 5, the present disclosure may include operation S110 of receiving sensor information, operation S120 of determining whether a sensor fails, operation S130 of verifying the reliability and integrity of data, operation S140 of detecting whether a transmission location is abnormal, and operation S150 of transmitting verified data.

Operation S110 is an operation in which the emergency determination unit 200 receives detection data of the sensor unit 100.

Operation S120 is an operation in which the emergency determination unit 200 determines whether a plurality of sensors included in the sensor unit 100 are faulty through the detection data of the sensor unit 100 and proceeds with operation S121 or operation S130.

For example, in the case of a failure of the radar 130, the emergency determination unit 200 does not determine an emergency type and transmits a determination failure message to the controller 400, and if at least one of the camera 110 and the lidar 120 fails, the emergency type may be determined and information may be transmitted to the controller 400 and/or the data checking unit 300.

Operation S121 is an operation in which, when a failure is detected by the plurality of sensors, the emergency determination unit 200 blocks data transmission to the data checking unit 300 and alerts the controller 400 of the failure.

Operation S130 is an operation in which the data checking unit 300 receives emergency detection information from the emergency determination unit 200 and verifies reliability by checking data integrity and whether there is any tampering. In other words, the data checking unit 300 diagnoses whether there is any tampering and integrity in the received data.

Here, the data checking unit 300 blocks transmission to the controller 400 if the received data is determined as data with low reliability as a result of the reliability verification.

Operation S140 is an operation in which the data checking unit 300 detects an abnormality in a transmission location of the data. The data checking unit 300 checks the transmission location at which the emergency situation is detected, determines whether there is a difference from the set information, and proceeds to steps S141 and S150.

Operation S141 is an operation in which the data checking unit 300 re-requests or blocks data from the emergency determination unit 200 if an abnormality in the transmission location is detected. The emergency determination unit 200 retransmits the corresponding data to the data checking unit 300 according to a request from the data checking unit 300. At this time, if an abnormality is detected in the retransmitted data, the data checking unit 300 blocks transmission of the corresponding data.

Operation S150 is an operation in which the data checking unit 300 transmits verification data to the controller 400 if the data meets set reliability criteria in the data reliability verification result.

Therefore, the controller 400 may receive emergency and/or disaster information including the verified data, analyze the received information, classify the information into a set grade, and transmit a response manual to the autonomous vehicle and the on-site terminal.

In this manner, in the present disclosure, since only the information whose reliability has been confirmed among various information collected from various detection devices installed on or around the road is selectively provided, reliable information may be provided to the autonomous vehicle, thereby enabling safe driving support.

While the disclosure has been described with reference to the accompanying drawings, it is to be understood that the scope of the disclosure is defined by the claims described hereinafter and should not be construed as being limited to the above-described embodiments and/or drawings. It is to be clearly understood that improvements, changes, and modifications that are obvious to those skilled in the art are also within the scope of the disclosure as defined in the claims.

What is claimed is:

1. A reliability check system for unexpected situation detection information in a mixed traffic flow of a mix of autonomous and non-autonomous vehicles, the reliability check system comprising:
a sensor unit configured to detect emergency and disaster situations on or around a road, including at least one of a camera, a lidar, and a radar;
an emergency determination unit configured to analyze information received from the sensor unit to determine an emergency type;
a controller configured to classify a set grade according to detection information from the emergency determination unit and transmit a response manual to an autonomous vehicle and an on-site terminal; and
a data checking unit configured to verify at least one of whether firmware of the information received from the emergency determination unit has been falsified, whether a vehicle is hacked by remote control, whether CAN tampering occurred, and whether communication channel tampering occurred, and transmit verified data to at least one of the controller and the autonomous vehicle.

2. The reliability check system of claim 1, wherein the emergency determination unit comprises:
a sensor information collecting module configured to collect at least one of 2D type object location information as coordinate system information and 3D type object location information, an object speed, an object direction, a blocked lane, and an emergency type as latitude and longitude information; and
a sensor data determination module configured to determine the data of the sensor unit to detect a type of an emergency situation, a section in which the emergency situation occurred, location information, and whether the sensor is broken.

3. The reliability check system of claim 1, wherein the emergency determination unit is configured to detect a failure in at least one of the camera, lidar, and radar and determines whether to transmit data to the data checking unit.

4. The reliability check system of claim 1, wherein the data checking unit is configured to detect whether there is an abnormality in a transmission location among the information received from the emergency determination unit and re-request the corresponding information from the emergency determination unit or blocks the corresponding information based on a detection result.

5. The reliability check system of claim 1, wherein the data checking unit is configured to send verified information to the controller and transmits at least one of the information transmitted to the controller, signal information, and detouring path information for avoiding an unexpected point to a surrounding autonomous vehicle and an infrastructure.

6. The reliability check system of claim 1, wherein the controller is configured to retransmit information including a location and type of an emergency received from the infrastructure to the infrastructure, but if there is a discrepancy between the received information and verified information, the controller is configured to correct the received information and then transmits corrected information to the infrastructure.

7. A reliability check method for unexpected situation detection information in a mixed traffic flow of a mix of autonomous and non-autonomous vehicles, the reliability check method comprising:
receiving, by an emergency determination unit, sensor data from a sensor unit including at least one of a camera, a lidar, and a radar and transmitting information including an emergency type and location;
verifying, by a data checking unit, at least one of whether firmware of the information received from the emergency determination unit has been falsified, whether a vehicle is hacked by remote control, whether CAN tampering occurred, whether communication channel tampering occurred, and whether integrity has been achieved; and
transmitting, by the data checking unit, information received from the emergency determination unit to a controller or blocking the information according to a verification result.

8. The reliability check method of claim 7, wherein the receiving includes checking, by the emergency determination unit, the sensor data of the sensor unit and detecting and alerting for a failure.

9. The reliability check method of claim 7, wherein the verifying further includes determining, by the data checking unit, whether there is an abnormality in a transmission location among the information of the emergency determination unit and requesting retransmission from the emergency determination unit or blocking the corresponding information if an abnormality is detected.
